(19) United States
(12) Patent Application Publication
(10) Pub. No.: US 2010/0014885 A1
(43) Pub. Date: Jan. 21, 2010

(54) System for Creating a Condition of Substantial Thermal Consistency Between Multiple Printer Cartridges

(76) Inventors: Joseph Edwin Domhoff, Shelbyville, KY (US); Kimberly Aubrey Thuringer, Lexington, KY (US); Edward Lynn Triplett, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 12/176,746

(22) Filed: Jul. 21, 2008

(51) Int. Cl. G03G 21/20

(52) U.S. Cl. 399/92

(57) ABSTRACT

A system for creating a condition of substantial thermal consistency between multiple printer cartridges includes a frame defining a cavity for supporting the multiple cartridges spaced apart from one another and a plurality of components mounted to the frame in flow communication with one another and with the cavity via the frame. The plurality of components coact with one another and with the frame to generate, regulate and distribute an intake flow of cooling air from the frame into multiple inflows of cooling air along different spaced apart paths at different velocities through the cavity and between the spaced apart multiple cartridges for causing transformation of the multiple inflows of cooling air into multiple outflows of heated air by contact with the multiple cartridges and to exhaust the multiple outflows of heated air from the cavity and frame.

### BACKGROUND

1. Field of the Invention

The present invention relates generally to a color printer with multiple cartridges and, more particularly, to a system for creating a condition of substantial thermal consistency between the multiple printer cartridges.

2. Description of the Related Art

A common color printer architecture that exists today is one that employs multiple printer cartridges in a vertical stack. A problem concerning printers which have this architecture is that the cartridges at the top of the stack not only generate their own heat, but also are affected by the heat produced from the cartridges below them. The result is that an overall condition of thermal inconsistency is created between the multiple cartridges wherein the cartridge at the top is the hottest and the cartridge at the bottom is the coolest. FIG. 1 is a diagrammatic depiction of a vertical stack of multiple printer cartridges wherein the different cross-hatched areas represent variations of the temperatures of the cartridges. The hot spots are on a right or drive side of the multiple cartridges. The upper two cartridges in the stack show higher temperatures than the lower two cartridges.

If the cartridges are not thermally consistent with each other, print quality will be compromised. Specifically, without thermal balance between the cartridges there will be an inconsistent toner mass in each cartridge as well as variability in the toner electrical charge in each cartridge. More thermal consistency between the multiple printer cartridges would thus reduce the variability between them in terms of toner mass and toner electrical charge.

Consequently, there is a need for an innovation that will promote greater thermal consistency between the multiple printer cartridges.

### SUMMARY OF THE INVENTION

The present invention meets this need by providing an innovation that adjusts the amount or velocity of cooling air inflow adjacent and across each of the multiple printer cartridges in order to substantially achieve thermal consistency throughout the cartridge stack. By adjusting the velocity of cooling air inflow to each individual cartridge, additional heat is removed from the hotter ones of the cartridges in the stack. However, this innovation is not just limited to multiple printer cartridges in vertical stacks but is believed applicable to multiple printer cartridges arranged in other orientations.

Accordingly, in an aspect of the present invention, a system for creating a condition of substantial thermal consistency between multiple printer cartridges includes a frame defining a cavity for supporting multiple printer cartridges spaced apart from one another and a plurality of components mounted to the frame in flow communication with one another and with the cavity via the frame and adapted to coact with one another and with the frame to generate, regulate and distribute an intake flow of cooling air from the frame into multiple inflows of cooling air along different spaced apart paths at different velocities through the cavity and between the spaced apart multiple printer cartridges therein for causing transformation of the multiple inflows of cooling air into multiple outflows of heated air by contact with the multiple printer cartridges and to exhaust the multiple outflows of heated air from the cavity and the frame.

In a further aspect of the present invention, a system for creating a condition of substantial thermal consistency between multiple printer cartridges includes a frame defining a cavity for supporting multiple printer cartridges spaced apart from one another and a plurality of components mounted on the frame and adapted to coact with one another in a complementary push-pull air flow operation that concurrently pushes an intake flow of cooling air through a first portion of the frame upstream of the cavity and into the cavity as multiple inflows of cooling air and pulls the multiple inflows of cooling air transformed into the multiple outflows of heated air from the cavity and through a second portion of the frame downstream of the cavity.

### BRIEF DESCRIPTION OF THE DRAWINGS

Having thus described the invention in general terms, reference will now be made to the accompanying drawings, which are not necessarily drawn to scale, and wherein:

FIG. 1 is a diagrammatic depiction of a vertical stack of multiple printer cartridges with different cross-hatched areas on the cartridges representing temperature variations as defined by a key included in FIG. 1.

FIG. 2 is a left side perspective view of a system according to the present invention for creating a condition of substantial thermal consistency between the multiple printer cartridges of FIG. 1, with portions of a frame of the system being shown in phantom outline form.

FIG. 3 is a right side perspective view of the system of FIG. 2 showing the different spaced apart paths of the multiple inflows of cooling air between the spaced apart multiple printer cartridges which are shown in phantom outline form.

FIG. 4 is an enlarged elevational view of a manifold of the system of FIG. 2.

FIG. 5 is an enlarged fragmentary view of the manifold of FIG. 4.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numerals refer to like elements throughout the views.

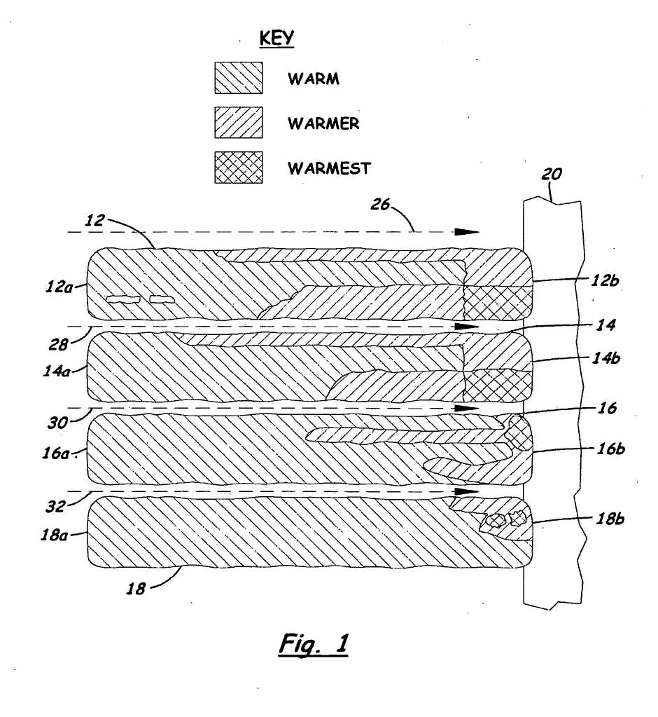

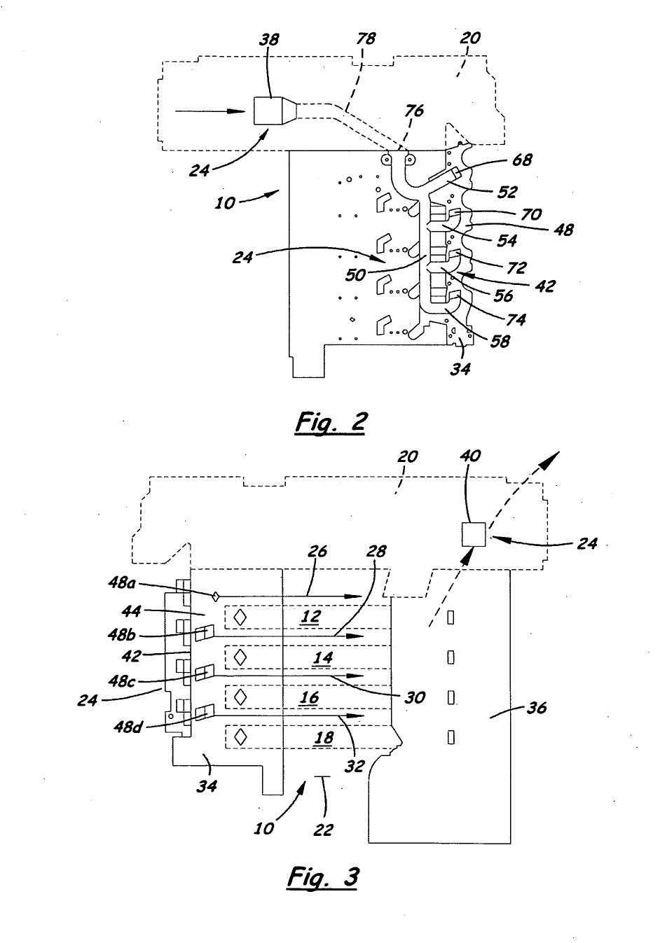

Referring now to FIG. 2 and 3, there is illustrated an exemplary embodiment of a system, generally designated 10, for creating a condition of substantial thermal consistency between multiple printer cartridges 12, 14, 16, 18, as shown in phantom outline form in FIGS. 1 and 3, in accordance with the present invention. The system 10 includes a frame, generally designated 20, supporting the cartridges 12-18 in a vertically spaced apart relationship with respect to each other in a stack form in a cavity 22 defined by the frame 20.

The system 10 also includes a plurality of components, generally designated 24, mounted to the frame 20 in flow communication with one another and with the cavity 22 via the frame 20. The components 24, which will be described in detail hereinafter, are adapted to coact with one another and with the frame 20 to generate, regulate and distribute an intake flow of cooling air from the frame 20 into multiple inflows of cooling air along different spaced apart paths, as represented by arrows 26, 28, 30, 32 in FIG. 3, at different velocities through the cavity 22 between and across the spaced apart multiple printer cartridges 12-18 therein, for causing transformation of the multiple inflows of cooling air into multiple outflows of heated air by contact with the multiple printer cartridges 12-18 and to exhaust the multiple outflows of heated air from the cavity 22 and the frame 20. The frame 20 is conventional per se and need not be described in any greater detail than necessary to describe the system 10 of the present invention of which the frame 20 is a part and how the plurality of components 24 of system 10 are associated with the frame 20.

The plurality of components 24 are further adapted to coact with one another in a complementary push-pull air flow operation that concurrently pushes the intake flow of cooling air through a first portion 34 of the frame 20 located upstream of the cavity 22 and into the cavity 22 as the multiple inflows of cooling air along the paths 26-32 and pulls the multiple inflows of cooling air transformed (by contact with the cartridges warmer than the cooling air) into the multiple outflows of heated air from the cavity 22 and through a second portion 36 of the frame 20 located downstream of the cavity 22. More particularly, the plurality of components 24 of the system 10 of the present invention include a first or cooling air intake blower fan 38, a second or heated air exhaust fan 40 and a manifold 42, all mounted to the frame 20 and cooperative with one another and with the frame 20 so as to implement the complementary push-pull air flow operation and provide the desired regulation and distribution of the velocities of inflows of cooling air across the cartridges 12-18 in the cavity 22. The cooling air intake blower fan 38 is mounted on the first portion 34 of the frame 20 adjacent the upstream end 44 of the cavity 22 and the non-drive ends 12a-18a of the cartridges 12-18, as seen in FIG. 1. The heated air exhaust fan 40 is mounted on the second portion 36 of the frame 20 adjacent the downstream end 46 of the cavity 22 and the drive ends 12b-18b of the cartridges 12-18, as seen in FIG. 1. The manifold 42 is mounted to a vertical wall portion 48 of the frame 20 at the upstream end 44 of the cavity 22 but on an opposite side of the vertical wall portion 48 from the cavity 22. The intake flow of cooling air generated by the intake blower fan 36 forces or pushes ambient air through the first or upstream portion 34 of the frame 20 into the cavity 22 utilizing the manifold 42. The exhaust fan 40 pulls the inflows of cooling air from the non-drive ends 12a-18a of the cartridges 12-18 adjacent the manifold 42 through the cavity 22 along airflow paths 26-32 and across the cartridges 12-18 to the drive ends 12a-18a of the cartridges before exiting the frame 20 via the exhaust fan 40.

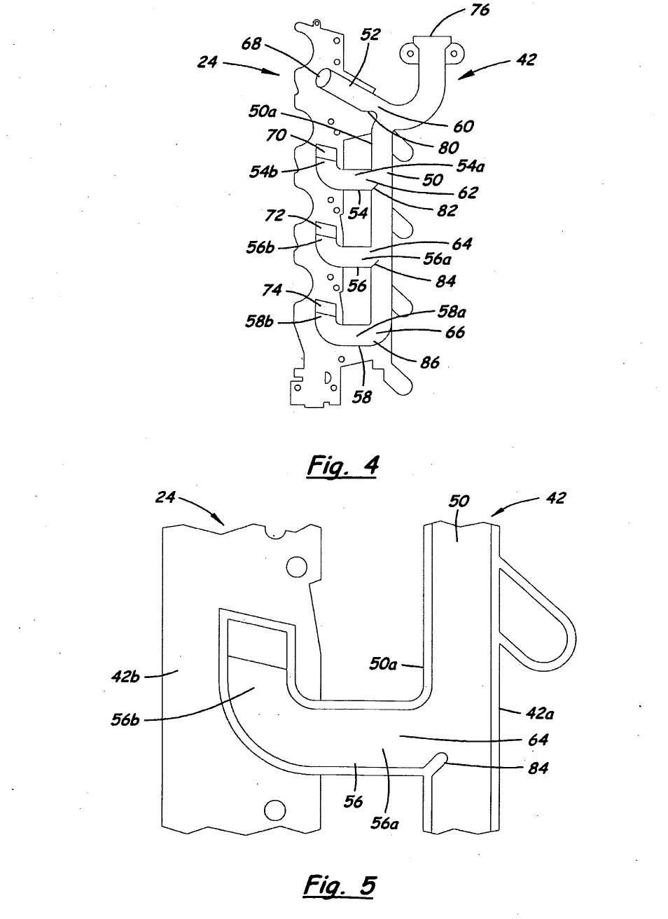

Referring now to FIGS. 4 and 5, the manifold 42, made of any suitable material, for example a suitable plastic material, has a configuration that divides or distributes the intake flow of cooling air, just prior to the cavity 22, into multiple unique inflows of cooling air that enter the cavity 22 and move along paths 26-32 across the multiple cartridges 12-18. In the illustrated example, since there are four cartridges 12-18 involved, there are four inflows of cooling air into the cavity 22 and along four paths 26-32 across the four cartridges 12-18. It is because of the differences in temperature between the four cartridges that there are four different air flow paths to promote thermal consistency.

With respect to its configuration which achieves this distribution of the cooling air flow, the manifold 42 has a main channel 50 running vertically and substantially lengthwise of the manifold 42 along one side portion 42a thereof, a plurality of chambers 52, 54, 56, 58 which branch off in the same direction from and in a generally transverse relationship to the main channel 50, and a plurality of vertically spaced apart entrances 60, 62, 64, 66 along one side edge 50a of the main channel 50 leading into the chambers 52-58. The chambers 52-58 lead to vertically spaced apart exit openings 68, 70, 72, 74 in an opposite side portion 42b of the manifold 42 which are aligned with openings 48a-48d in the vertical wall portion 48 of the frame 20 that lead into the cavity 22 when the manifold 42 is fastened against the frame 20, as shown in FIGS. 2 and 3. The uppermost chamber 52 has an inclined orientation, while the other three lower chambers 54-58 have respective transverse portions 54a, 56a, 58a extending horizontally and upturned portions 54b, 56b, 58b extending vertically through about the same distances. Once the manifold 42 is fastened to the vertical wall portion 48 of the frame 20 the main channel 50 and chambers 52-58 are sealed with the frame 20 except for exit openings 68-74 and an upper inlet 76 to the main channel 50 which is in flow communication with the intake blower fan 38 via a passage 78 or other suitable conduit feature through the first or upstream portion 34 of the frame 20.

In order to create the condition of substantial thermal consistency between the vertically stacked multiple cartridges 12-18, the velocities of the four inflows of cooling air along the paths 26-32 and across the multiple cartridges 12-18 must be tailored to match the cooling requirements for the cartridges. Since the temperatures of the cartridges 12-18 are different from one to the next, the velocities of the inflows of cooling air along the paths 26-32 are likewise different from one to the next. The higher the velocity of an inflow of cooling air, the more heat that can be removed from the particular cartridge. For cartridges that are vertically stacked, higher velocities of air flow on the upper cartridges remove more heat from them. This makes the upper cartridges more consistent with the lower cartridges temperature wise.

Not only is the intake flow of cooling air flow into the main channel 50 of the manifold 42 divided into four inflows by the four chambers 52-58, the manifold 42 also has elements therein, which can take various exemplary forms, to regulate the velocities of the four inflows to be different from each other and tailored to match the temperature differences of the four cartridges 12-18 to achieve substantial thermal consistency. In one exemplary form, these elements are baffles 80, 82, 84, 86 each provided at a downstream side of one of the entrances 60-66 to the chambers 52-58. The existence of the baffles 80-86 allows for control and regulation of the amount or velocity of air flow into a given one of the chambers 52-58. By changing the length or the angle of the baffles 80-86, air flow velocity can be decreased or increased into the cartridge cavity 22. By allowing more air flow into the top two chambers 52, 54 of the manifold 42 and less into the bottom two chambers 56, 58, more cooling air flow is allowed to cool the top two cartridges 12, 14. The result is substantial thermal consistency along the cartridge doctor blades (not shown). In another exemplary form, these elements are different sizes and diameters of the openings 68-74 in the manifold 42 and/or openings 48a-48d in the vertical wall portion 48 of the frame 20 to modify the amount of air flow therethrough. In still another exemplary form, these elements are different cross-sectional sizes of the individual air flow chambers 46-62 in the manifold 42 to modify the amount of air flow therethrough.

In view of the foregoing description of the various aspects of the system 10 of the present invention with reference to the figures of the attached drawings, the following benefits or advantages that derive from the system 10 can now be more readily understood and appreciated. First, by adjusting the velocity of each of the respective inflows of cooling air to the individual ones of cartridges 12-18 the additional heat can be removed from the hotter ones of the cartridges. Second, substantial thermal consistency of the cartridges 12-18 is ensured by using the complementary push-pull air flow operation. Third, the use of the manifold 42 provides a simplified approach to satisfying the requirements for dividing, regulating and distributing the intake flow of cooling air, such as ambient air, into inflows of cooling air with velocities tailored to meet the cooling requirements of the cartridges 12-18. Fourth, there are several alternative design approaches available from which to choose to accomplish the division and regulation of the intake flow of cooling air by the manifold 42.

The foregoing description of several embodiments of the invention has been presented for purposes of illustration. It is not intended to be exhaustive or to limit the invention to the precise forms disclosed, and obviously many modifications and variations are possible in light of the above teaching. It is intended that the scope of the invention be defined by the claims appended hereto.

What is claimed is:

1. A system for creating a condition of substantial thermal consistency between multiple printer cartridges, said system comprising:
a frame defining an open cavity for supporting multiple printer cartridges spaced apart from one another in a substantially vertically stacked arrangement, the stacked printer cartridges defining vertically spaced apart air flow passages formed between adjacent ones thereof; and
a plurality of components mounted to said frame in flow communication with one another and with said cavity via said frame, to generate, regulate and distribute a single intake flow of cooling air from said frame into multiple, vertically stacked, parallel inflows of cooling air along different spaced apart paths corresponding to the vertically spaced apart air flow passages at different velocities through said open cavity for causing transformation of the multiple inflows of cooling air into multiple outflows of heated air by contact with the multiple printer cartridges and to exhaust the multiple parallel outflows of heated air from said cavity and said frame.

2. The system of claim 1 wherein said plurality of components are adapted to coact with one another in a complementary push-pull air flow operation that concurrently pushes the intake flow of cooling air through a first portion of said frame upstream of said cavity and into said cavity as multiple inflows of cooling air and pulls the multiple inflows of cooling air transformed into the multiple outflows of heated air from said cavity and through a second portion of said frame downstream of said cavity.

3. The system of claim 2 wherein a first of said components is a first fan mounted to said first portion of said frame and operable to generate the intake flow of cooling air into said first portion of said frame and to push the intake flow of cooling air through said first portion of said frame toward and into said cavity.

4. The system of claim 3 wherein a second of said components is a second fan mounted to said second portion of said frame and operable to pull and exhaust the multiple outflows of heated air from said cavity and said second portion of said frame there being no component disposed between the open cavity and the second fan..

5. The system of claim 4 wherein a third of said components is a manifold mounted to said first portion of said frame adjacent to and in communication between said cavity and said first fan via said first portion of said frame and operable to receive the intake flow of cooling air pushed from said first fan and to regulate and distribute the intake flow of cooling air into the multiple inflows of cooling air of different velocities along said different spaced apart paths through said cavity and between the spaced apart multiple cartridges where the multiple inflows of cooling air are transformed into multiple outflows of heated air pulled and exhausted from said cavity and second portion of said frame by said second fan.

6. The system of claim 5 wherein said manifold has a main channel leading from an inlet opening in flow communication with said first fan, a plurality of chambers branching off from said main channel and leading to exit openings in said manifold in flow communication with said different paths across said cavity of said frame, and a plurality of entrances on said main channel leading into said chambers, at least two of said chambers having a substantially J-shaped cross section.

7. The system of claim 6 wherein said manifold has baffles provided at said entrances to said chambers for regulating the velocity of air flow into said chambers.

8. The system of claim 6 wherein said exit openings of said manifold have different sizes for regulating the amount of air flow therethrough into said cavity.

9. The system of claim 6 wherein said frame has openings leading into said cavity of different sizes for regulating the amount of air flow therethrough into said cavity.

10. The system of claim 6 wherein said chambers of said manifold have different cross-sectional sizes for regulating the amount of air flow therethrough.

11. The system of claim 1 wherein one of said components is a manifold mounted to said frame adjacent to and in communication with said cavity and operable to receive an intake flow of cooling and to regulate and distribute the intake flow of cooling air into multiple inflows of cooling air of different velocities along said different spaced apart paths through said cavity and between the spaced apart multiple cartridges where the multiple inflows of cooling air are transformed into multiple outflows of heated air exhausted from said cavity and said frame.

12. The system of claim 11 wherein said manifold has a main channel leading from an inlet opening in flow communication with said intake flow of cooling air, a plurality of chambers branching off from said main channel and leading to exit openings in said manifold in flow communication with said different paths across said cavity of said frame, and a plurality of entrances on said main channel leading into said chambers.

13. The system of claim 12 wherein said manifold has baffles provided at said entrances to said chambers for regulating the velocity of air flow into said chambers.

14. The system of claim 12 wherein said exit openings of said manifold has different sizes for regulating the amount of air flow therethrough into said cavity.

15. The system of claim 12 wherein said frame has openings leading into said cavity of different sizes for regulating the amount of air flow therethrough into said cavity.

16. The system of claim 12 wherein said chambers of said manifold have different cross-sectional sizes for regulating the amount of air flow therethrough.

17. A system for creating a condition of substantial thermal consistency between multiple printer cartridges, said system comprising:
a frame defining an open cavity for supporting multiple printer cartridges vertically spaced apart from one another and defining substantially parallel, substantially vertically spaced air flow passages between adjacent ones of the printer cartridges; and
a plurality of components mounted on said frame for coacting with one another in a complementary push-pull air flow operation that concurrently pushes an intake flow of cooling air through a first portion of said frame upstream of said cavity and into said open cavity as multiple parallel, vertically spaced inflows of cooling air passing through the air flow passages between adjacent printer cartridges, and pulls the multiple inflows of cooling air transformed into the multiple outflows of heated air from said cavity and through a second port ion of said frame downstream of said cavity.

18. The system of claim 17 wherein one of said components is a manifold mounted to said first portion of said frame adjacent to and in communication with said cavity and operable to receive said intake flow of cooling and to regulate and distribute the intake flow of cooling air into multiple inflows of cooling air of different velocities along said different spaced apart paths through said cavity and between the spaced apart multiple cartridges where the multiple inflows of cooling air are transformed into multiple outflows of heated air exhausted from said cavity and said second portion of said frame.

19. The system of claim 18 wherein another of said components is a first fan mounted to said first portion of said frame and operable to generate the intake flow of cooling air into said first portion of said frame and to push the intake flow of cooling air through said first portion of said frame toward and into said cavity.

20. The system of claim 19 wherein still another of said components is a second fan mounted to said second portion of said frame and operable to pull and exhaust the multiple outflows of heated air from said cavity and said second portion of said frame, there being no components disposed between the open cavity and the second fan.
